(19) United States
(12) Patent Application Publication
(10) Pub. No.: US 2015/0341432 A1
(43) Pub. Date: Nov. 26, 2015

(54) GROUPING METHOD, CLIENT, SERVER, AND SYSTEM

(71) Applicant: GUANGZHOU HUADUO NETWORK TECHNOLOGY CO., LTD, Guangzhuo, Guangdong (CN)

(72) Inventors: Xuechou YANG, Guangzhou, Guangdong (CN); Youbin WANG, Guangzhou, Guangdong (CN); Guangxing XU, Guangzhou, Guangdong (CN)

(21) Appl. No.: 14/654,052

(22) PCT Filed: Dec. 5, 2013
(86) PCT No.: PCT/CN2013/088659

§ 371 Date: Jun. 19, 2015

(30) Foreign Application Priority Data
Dec. 24, 2012 (CN) 201210271842.3

(51) Int. Cl. H04L 29/08

(52) U.S. Cl. CPC H04L 67/1048; H04L 67/1046

(57) ABSTRACT

Disclosed are a grouping method, client, server, and system, which belong to the field of the Internet communications. The method includes: receiving a group initiation request sent by a first client in a current channel, the group initiation request carrying an identifier of the first client; sending group state information to all clients in the current channel; receiving a group joining request sent by a second client in the current channel, the group joining request including an identifier of second client and a position that the second client is to join; sending group state information to all clients again; after every position has a corresponding identifier of a joined client, moving joined clients corresponding to all positions into the same sub-channel to accomplish grouping. This disclosure realizes that as long as the first client initiates a group, the second client can join the group freely to accomplish a grouping operation.

### CROSS REFERENCE TO RELATED APPLICATIONS

This present application is a U.S. National Stage Application of International Patent Application No. PCT/CN2013/088659, filed on Dec. 5, 2013, which claims the benefit of priority to Chinese Patent Application No. 201210571842.3 filed on Dec. 24, 2012 and entitled “GROUPING METHOD, CLIENT, SERVER AND SYSTEM”, the entire contents of which are hereby incorporated by reference in their entirety.

### TECHNICAL FIELD

The disclosure relates to the field of Internet communications, and particularly to a grouping method, a client, a server and a system.

### BACKGROUND

A group communication tool is a widely used and popular instant messaging application. The group communication tool is usually used in multi-user conference, online teaching, grouping cooperation, karaoke TV and other application scenarios.

When the group communication tool is used to realize a grouping cooperation, a common grouping method often includes: a current client entering or establishing an empty channel in the group communication tool, and transferring the channel number of the empty channel to the other clients which want to join a group, for example, a user of the current client sending the channel number to other users of other clients by telephone calling, short-massage or text message of instant messaging; the users of the other clients joining the empty channel according to the channel number when learning the channel number of the empty channel to make every client which wants to join the group enters in the same channel; and performing a voice communicating in the empty channel.

However, in the process of implementation of the present disclosure, the inventor finds the existing technology exists at least the following problems: the current client has to send the channel number to the other clients that want to join the group, only if the other clients know the channel number, and then they can form a group successfully. If the user of the current client and the users of the other clients do not know each other, the grouping operation usually cannot be completed successfully.

### SUMMARY

Embodiments of the present disclosure provide a grouping method, a client, a server and a system, in order to solve the problem of unable to form a group successfully when a channel number is not known to other clients. The technical solution will be provided as follows.

According to a first aspect of the present disclosure, a grouping method is provided, the method includes the following steps of: receiving a group initiation request sent by a first client in a current channel, the group initiation request carrying an identifier of the first client; sending group state information to all clients in the current channel, wherein the group state information includes all the following four pieces or the first three pieces of content in the total number of positions, content types of the position, corresponding relationship between each position and an identifier of a joined client and group joining requirements, wherein the corresponding relationship includes a corresponding relationship between first position and an identifier of first client; receiving a group joining request sent by a second client in the current channel, the group joining request including an identifier of the second client and a position that the second client is to join; updating the group state information and sending the group state information to all clients again in the current channel, wherein the corresponding relationship in the group state information includes a corresponding relationship between the second position and the identifier of to second client; and after every position has a corresponding identifier of a joined client, moving joined clients corresponding to all positions into the same sub-channel to accomplish grouping.

Wherein after the step of receiving a group initiation request sent by a first client in the current channel, and before the step of sending group state information to all clients in the current channel, further includes a step of: reading group setting information preset by a client where an administrator of the current channel is located, wherein the group setting information includes all the following three pieces or the first two pieces of content in the total number of the positions, the content types of the positions and the group joining requirements.

Wherein, after the step of receiving a group joining request sent by a second client in the current channel, and before the step of sending the group state information to all clients again in the current channel, further includes steps of: detecting whether or not the identifier of the joined client corresponding to the position that the second client is to join is empty; if the identifier of the joined client corresponding to the position that the second client is to join is empty, implementing the step of sending the group state information to all clients again in the current channel; and else if the identifier of the joined client corresponding to the position that the second client is to join is not empty, sending the group state information to the second client again, wherein the group state information is currently latest group state information.

Wherein, after the step of sending the group state information to all clients again in the current channel, wherein the corresponding relationship in the group state information includes a corresponding relationship between second position and an identifier of the second client, further includes steps of: receiving a group quitting request sent by the second client, the group quitting request including the identifier of the second client and the position that the second client is to quit; and updating the group state information and sending the group state information to all clients again in the current channel, the corresponding relationship in the group state information having removed the corresponding relationship between the second position and the identifier of the second client.

Wherein, after the step of receiving a group quitting request sent by the second client and before the step of sending the group state information to all clients again in the current channel, further includes steps of: detecting whether or not the identifier of the joined client corresponding to the position that the second client is to quit is the same as the identifier of the second client; if the identifier of the joined client corresponding to the position that the second client is to quit is the same as the identifier of the second client, implementing the step of sending the group state information to all the clients again in the current channel; and else if the identifier of the joined client corresponding to the position that the second client is to quit is different from the identifier of the second client, sending the group state information to the second client again, wherein the group state information is currently latest group state information.

Wherein, after the step of sending the group state information to all clients again in the current channel, wherein the corresponding relationship in the group state information includes a corresponding relationship between second position and the identifier of the second client, further includes steps of: receiving a group member kicking-out request sent by the first client, the group member kicking-out request including the corresponding relationship between the second position and the identifier of the second client; and updating the group state information and sending the group state information to all clients again in the current channel, the corresponding relationship in the group state information having removed the corresponding relationship between the second position and the identifier of the second client.

Wherein, after the step of receiving a group member kicking-out request sent by the first client and before the step of sending the group state information to all clients again in the current channel, further includes steps of: detecting whether or not the identifier of the joined client corresponding to the second position in the group member kicking-out request is the same as the identifier of the second client; if the identifier of the joined client corresponding to the second position in the group member kicking-out request is the same as the identifier of the second client, implementing the step of sending the group state information to all clients again in the current channel; and else if the identifier of the joined client corresponding to the second position in the group member kicking-out request is different from the identifier of the second client, sending the group state information to the first client again, wherein the group state information is currently latest group state information.

Wherein, before the step of receiving a group joining request sent by a second client in the current channel, further includes steps of: receiving a group state reading request sent by a second client which newly enters in the current channel; and sending the second client the group state information again, which is currently latest group state information.

Wherein, after the step of sending group state information to all clients in the current channel, further includes steps of: receiving a group cancelling request sent by the first client or a client where the administrator of the current channel is located, wherein the group cancelling request sent by the first client is a request that is actively initiated by a user or is automatically triggered after a predetermined period of sending the group initiation request; and updating the group state information and sending the group state information to all clients in the current channel again, wherein the group state information includes all the following four pieces or the first three pieces of content in the total number of the positions, the content types of the positions, the corresponding relationship between each position and the identifier of the joined client and the group joining requirements, wherein the corresponding relationship is empty.

Wherein, the step of after every position has a corresponding identifier of a joined client, moving joined clients corresponding to all positions into the same sub-channel to accomplish grouping, further includes steps of: after every position has a corresponding identifier of a joined client, receiving grouping accomplishing information sent by a client where an administrator of the current channel is located; and moving the joined clients corresponding to all the positions into the same sub-channel to accomplish grouping upon receiving the grouping accomplishing information.

The method further includes steps of: utilizing a channel server as a transfer server to receive requests sent by every client in the current channel; and/or, utilizing the channel server as the transfer server to send information to every client in the current channel in form of broadcasting mode or unicasting mode.

According to a second aspect of the present disclosure, a grouping method used in the first client is provided, the method includes steps of: sending a group initiation request to a grouping server, the group initiation request carrying the identifier of the first client; receiving group state information sent by the grouping server, wherein the group state information including all the following four pieces or the first three pieces of content in the total number of the positions, the content types of the positions, the corresponding relationship between each position and the identifier of a joined client and the group joining requirements, wherein the corresponding relationship includes a corresponding relationship between the first position and the identifier of the first client; receiving the group state information sent again by the grouping server, wherein corresponding relationship in the group state information includes a corresponding relationship between second position and the identifier of the second client; and after every position has a corresponding identifier of a joined client, entering the same sub-channel with other joined clients to accomplish grouping.

According to a third aspect of the present disclosure, a grouping method used in the second client is provided, the method includes steps of: receiving group state information sent by a grouping server, wherein the group state information including all the following four pieces or the first three pieces of content in the total number of the positions, content types of the positions, corresponding relationship between each position and an identifier of a joined client and the group joining requirements, wherein the corresponding relationship includes a corresponding relationship between first position and an identifier of the first client; sending a group joining request to the grouping server, the group joining request including identifier of the second client and a position that the second client is to join; receiving the group state information sent again by the grouping server, wherein corresponding relationship in the group state information includes a corresponding relationship between second position and the identifier of the second client; and after every position has a corresponding identifier of a joined client, moving joined clients corresponding to all positions into the same sub-channel to accomplish grouping.

According to a forth aspect of the present disclosure, a grouping server is provided, the server includes: a first receiving module, configured to receive a group initiation request sent by a first client in the current channel, the group initiation request carrying an identifier of the first client; a state broadcasting module, configured to send group state information to all the clients in the current channel, wherein the group state information includes all the following four pieces or the first three pieces of content in the total number of positions, content types of the position, corresponding relationship between each position and an identifier of a joined client and group joining requirements, wherein the corresponding relationship includes a corresponding relationship between the first position and an identifier of the first client; a second receiving module, configured to receive a group joining request sent by a second client in the current channel, the group joining request including an identifier of the second client and a position that the second client is to join; the state broadcasting module further configured to update the group state information and send the group state information to all clients again in the current channel, wherein the corresponding relationship in the group state information includes the corresponding relationship between the second position and the identifier of the second client; and a channel shifting-in module, configured to move each joined client corresponding to each position into the same sub-channel after every position has a corresponding identifier of a joined client received from the first receiving module or the second receiving module.

According to a fifth aspect of the present disclosure, a first client is provided, the first client includes: a first sending module, configured to send a group initiation request to grouping server, the group initiation request carrying an identifier of the first client; a state receiving module, configured to receive group state information sent by the grouping server, wherein the group state information includes all the following four pieces or the first three pieces of content in the total number of positions, content types of the position, corresponding relationship between each position and an identifier of a joined client and group joining requirements, wherein the corresponding relationship includes a corresponding relationship between the first position and an identifier of the first client; the state receiving module, further configured to receive the group state information sent again by the grouping server, wherein corresponding relationship in the group state information includes a corresponding relationship between second position and an identifier of the second client; and a channel entering module, configured to enter the same sub-channel with other joined clients to accomplish grouping after every position has a corresponding identifier of a joined client.

According to a sixth aspect of the present disclosure, a second client is provided, the second client includes: a state receiving module, configured to receive group state information sent by the grouping server, wherein the group state information includes all the following four pieces or the first three pieces of content in the total number of the positions, content types of the positions, corresponding relationship between each position and an identifier of a joined client and group joining requirements, wherein the corresponding relationship includes a corresponding relationship between first position and an identifier of first client; a second sending module, configured to send a group joining request to the grouping server, the group joining request including an identifier of the second client and a position that the second client is to join; the state receiving module, further configured to receive the group state information sent again by the grouping server, wherein the corresponding relationship in the group state information includes a corresponding relationship between second position and the identifier of the second client; and a channel entering module, configured to enter the same sub-channel with other joined clients to accomplish grouping after every position has a corresponding identifier of the joined client.

According to a seventh aspect of the present disclosure, a grouping system is provided, the grouping system includes a grouping server, a first client and a second client; the grouping server is a grouping server according to such as the fourth aspect or every further scheme of the fourth aspect of present disclosure; the first client is a first client according to such as the fifth aspect or every further scheme of the fifth aspect of present disclosure; and the second client is a second client according to such as the sixth aspect or every further scheme of the sixth aspect of present disclosure.

According to an eighth aspect of the present disclosure, a grouping system is provided, the grouping system includes a grouping server, a first client, a second client and a channel server; wherein, the grouping server is a grouping servers according to such as the last scheme of the forth aspect of present disclosure; the first client is a first client according to such as the fifth aspect or every further scheme of the fifth aspect of present disclosure; and the second client is a second client according to such as the sixth aspect or every further scheme of the sixth aspect of present disclosure.

By means of receiving the group initiation request sent by the first client, then sending the group state information to all clients in the current channel, and receiving the group joining request sent by the second client in the current channel, embodiments of the present disclosure solve the problem of unable to form a group successfully when the channel number is not known to other clients; achieve the effect that as long as the first client initiates a group request in the current channel, the second client can join the group freely to accomplish the grouping operation.

### BRIEF DESCRIPTION OF DRAWINGS

In order to illustrate the embodiments or existing technical solutions more clearly, a brief description of drawings that assists the description of embodiments of present disclosure or existing art will be provided below. It would be apparent that the drawings in the following description are only for some of the embodiments of the disclosure. A person having ordinary skills in the art will be able to obtain other drawings on the basis of these drawings without paying any creative work.

FIG. 1 is a method flowchart of a grouping method provided by a first embodiment of the present disclosure.

FIG. 2 is a structure diagram of implementing environment according to a second embodiment of the present disclosure.

FIG. 3 is a method flowchart of a grouping method provided by the second embodiment of the present disclosure.

FIGS. 4A to 4D are implementing diagrams of the grouping method according to the second embodiment of the present disclosure.

FIG. 5 is a structure diagram of a grouping system provided by a third embodiment of the present disclosure.

FIG. 6 is a structure diagram of a grouping system provided by a forth embodiment of the present disclosure; and

FIG. 7 is a structure diagram of a channel shifting-in module according to a forth embodiment of the present disclosure.

### DETAILED DESCRIPTION

In order to make the objective, technical solution and advantages of this disclosure more clear, further description will be given in the following embodiments combined with drawings.

Embodiment One

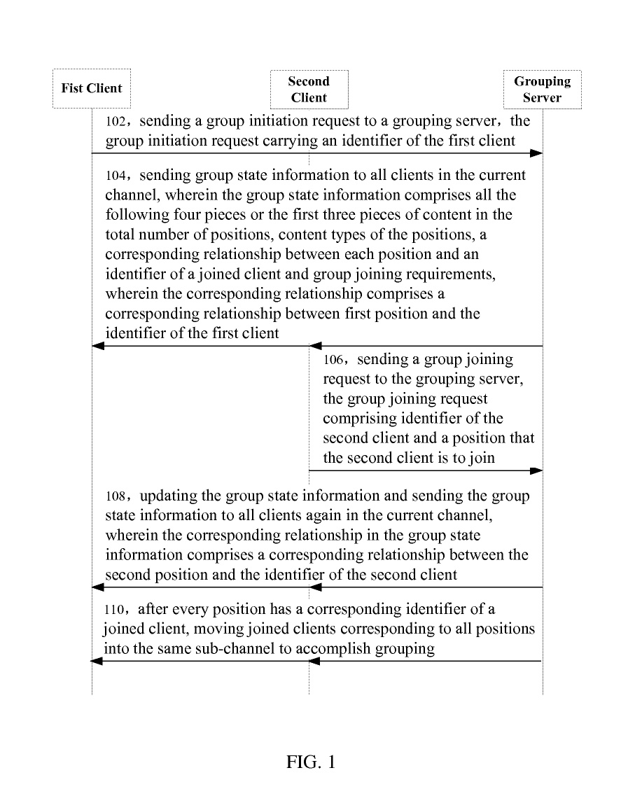

Please refer to FIG. 1, which is a method flowchart of a grouping method provided by a first embodiment of the present disclosure. The embodiment is mainly described by the example of applying this grouping method to the grouping system which includes a first client, at least one second client and a grouping server. Each client is connected to the grouping server through network connection, such as TCP (Transmission Control Protocol) or UDP (User Datagram Protocol) connection. In this embodiment, the grouping method includes the following steps.

Step 102, the first client sends a group initiation request to the grouping server in a current channel, wherein the group initiation request carries an identifier of the first client.

A group communication tool usually divides all the users into the different channels or sub-channels according to the category of the user or according to the requirement, for example, “90's song party” channel, “xx vocal concert” channel, “xx game comment” channel or “communications of Chinese ancient civilization” channel, etc. The channel, which also can be called the showing room, chatting room or other names, is a communication area where all users who have the same communication theme join in. The information of users belonging to a channel is kept in a network server. A group represents a team including a number of team members, wherein the team members are players of the team. Taking a scenario that one channel includes many clients as an example, when in need of grouping, the first client sends the group initiation request to the grouping server in the current channel, wherein the group initiation request carries the identifier of the first client. The identifier of the first client is configured to uniquely identify the identification of the first client in the group communication tool.

Accordingly, the grouping server receives the group initiation request sent by the first client in the current channel, wherein the group initiation request carries the identifier of the first client.

Step 104, the grouping server sends group state information to all clients in the current channel, wherein the group state information includes all four pieces of content or the first three pieces of content in the total number of positions, content types of the positions, a corresponding relationship between each position and an identifier of a joined client and group joining requirements, and the corresponding relationship includes a corresponding relationship between a first position and the identifier of the first client.

After receiving the group initiation request sent from the first client in the current channel, the grouping server sends the group state information to all clients in the current channel. The group state information includes all four pieces of content or the first three pieces of content in the total number of positions, content types of the positions, a corresponding relationship between each position and an identifier of a joined client and group joining requirements, wherein, the corresponding relationship includes a corresponding relationship between the first position and the identifier of the first client. The total number of positions can be the number of occupied positions and non-occupied positions, or the number of non-occupied positions. One position indicates one position of a group member in a group, for example, a group has 5 positions, which means the group needs 5 group members in total. The content types of the positions indicate the information that needs to be showed in the position, and the information usually includes the identifier of the joined client and introduction information of the joined client and so on. The corresponding relationship between each position and the identifier of a joined client represents the corresponding relationship between the identity of a client in the position and the position when the client joins in the position, such as, the corresponding relationship between an identifier “0981” of a client A and a second position when the client A joining in the second position. The group joining requirements are optional content, which usually at least includes one of the following items: whether a contribution value of the current channel reaching a predetermined threshold, whether a current reward points reaching a predetermined threshold and whether privilege of the current channel reaching a requirement of predetermined privilege.

Since the group initiation request is initiated by the first client, the first client will be acquiescently considered to be a team leader to join in the first position. The corresponding relationship in the group state information sent by the grouping server this time includes the corresponding relationship between the first position and the identifier of the first client.

Accordingly, all the clients in the current channel will receive the group state information sent by the grouping server, for instance, the first client and at least one second client will receive the group state information sent by the grouping server.

Step 106, the second client sends a group joining request to the grouping server in the current channel, wherein the group joining request includes an identifier of the second client and a position that the second client is to join.

The second client can acquire current group state after receiving the group state information sent by the grouping server. When the second client needs to join the group, the second client sends the group joining request to the grouping server, wherein the group joining request includes the identifier of the second client and the position that the second client is to join. For example, the group state information that the grouping server sends to the second client includes: the total number “5” of the positions, the content types “the identifier of the joined client” of the positions, the corresponding relationship of “the identifier of the first client corresponding to the first position, and the identifiers of the joined clients corresponding to the other four positions being empty”; wherein the second client can send the group joining request to the grouping server, and the group joining request includes the identifier of the second client and the position that the second client is to join.

Accordingly, the grouping server can receive the group joining request sent by the second client, and make the identifier of the second client correspond to the second position after receiving the group joining request, and add the identifier of the second client and the second position into the corresponding relationship.

Step 108, the grouping server updates the group state information and sends the group state information to all clients again in the current channel, wherein the corresponding relationship in the group state information includes a corresponding relationship between the second position and the identifier of the second client.

In order to make other clients get to know that the second client has joined in the second position, the grouping server updates the group state information and sends the group state information to all the clients again in the current channel, wherein the corresponding relationship in the group state information include the corresponding relationship between the second position and the identifier of the second client. All the clients in the current channel include the first client and the second client.

What need to be specified is, the number of second clients can be more than one, for example, when the position number is 5, 4 second clients can join in the group to become the group member of this group. That is, step 106 and step 108 may be implemented repeatedly.

Step 110, after every position has a corresponding identifier of a joined client, the grouping server moves joined clients corresponding to all positions into the same sub-channel to accomplish grouping.

In detail, after every position has a corresponding identifier of a joined client, the grouping server moves joined clients corresponding to all positions into the same sub-channel to accomplish grouping. For example, when the total amount of positions is 5, if each of 5 positions has a client to be joined, that is, 5 positions correspond to 5 clients, then the grouping server can move the 5 clients into the same sub-channel to accomplish grouping.

For the first client or the second client, after every position has a corresponding joined client, the first client or the second client itself and other joined clients enter and join the same sub-channel together.

In conclusion, by means of receiving a group initiation request sent by the first client in the current channel, sending the group state information to all clients in the current channel and receiving a group joining request sent by the second client in the current channel according to the group state information, the grouping method provided in this embodiment solves the technical problem of unable to form a group successfully when other clients do not know a channel number, and also achieves the effect that as long as the first client initiates a grouping operation in a current channel, the second client can join the group freely to accomplish the grouping operation.

It's important to note that, according to different implementing bodies, some steps of the grouping method described-above can be divided into corresponding grouping methods which can be performed by the grouping server, the first client and the second client separately.

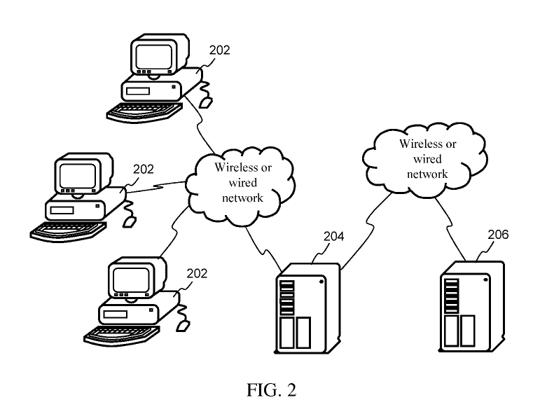

Referring to FIG. 2, it is a structure diagram of implementing environment according to a second embodiment of present disclosure. This implementing environment includes at least one client 202, a channel server 204 and a grouping server 206.

Each client 202 is connected to the channel server 204 through wireless or wired network.

The channel server 204 is connected to the grouping server 206 through wireless or wired network.

The channel server 204 has the capability of transparently transmitting, broadcasting and unicasting. Each client 202 does not directly communicate with the grouping server 206.

Specifically, when each client 202 sends request information to the grouping server 206, the channel server 204 as a transfer server will send the request information to the grouping server 206 through a transparent passageway.

The grouping server 206 will have a corresponding processing after receiving the request information. When the grouping server 206 needs to send information to all or part of clients 202, it will send the information to the channel server 204 at first.

When receiving the information, the channel server 204 will send the information to all or a part of clients 202 in the form of broadcasting or unicasting.

Embodiment Two

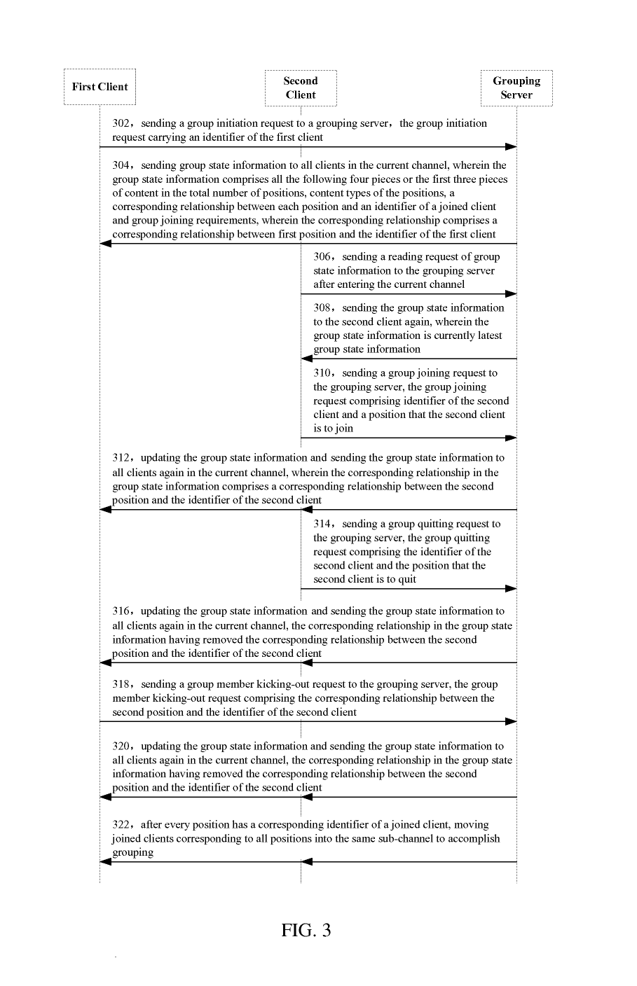

Referring to FIG. 3, it is a method flowchart of a grouping method provided by the second embodiment of the present disclosure. This embodiment is mainly illustrated by the example of applying this grouping method to the implementing environment as showed in the FIG. 2. The grouping method at least includes steps as follows.

Step 302, a first client sends a group initiation request to a grouping server in a current channel, wherein the group initiation request carries an identifier of the first client.

Taking a scenario of the current channel including many clients as an example, when in need of grouping, the first client sends the group initiation request to the grouping server in the current channel, wherein the group initiation request carries the identifier of the first client. The identifier of the first client is configured to uniquely identify the identification of the first client in the group communication tool.

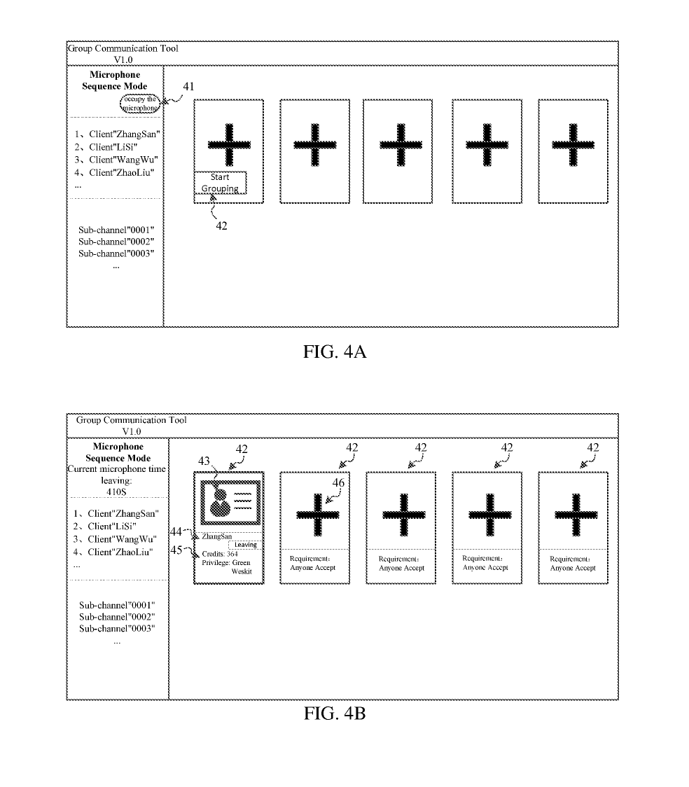

In the group communication tool, when the first client initiates a grouping operation, then the first client will become the microphone occupier person in a current microphone sequence. A microphone sequence mode is an operation mode that many microphone time periods are divided into in the current channel, in each microphone time period only one client can occupy the microphone (i.e., the microphone occupier), and other clients only can listen or send text messages. Combined with FIG. 4A, the first client can click a “occupy microphone” button 41 on a current user interface or click a “start grouping” button 42 on the first position to send the group initiation request to the grouping server.

Accordingly, the grouping server receives the group initiation request sent by the first client in the current channel, wherein the group initiation request carries the identifier of the first client.

Step 304, the grouping server sends group state information to all clients in the current channel, wherein the group state information including all four pieces of content or the first three pieces of content in the, total number of positions, content types of the position, the corresponding relationship between each position and an identifier of a joined client and the group joining requirements, wherein the corresponding relationship includes a corresponding relationship between the first position and the identifier of the first client. The total number of positions can be the number of occupied positions and non-occupied positions, or the number of non-occupied positions.

After receiving the group initiation request sent by the first client in the current channel, the grouping server sends the group state information to all the clients in the current channel, wherein the group state information includes all four pieces of content or the first three pieces of content in the total amount of the positions, the content types of the position, the corresponding relationship between every position and the identifier of the joined client and the group joining requirements. One position indicates one position of one group member of a group, for example, a group has 5 positions, which means the group needs 5 group members in all. The content types of the position indicates the information that needs to be showed on the position, and the information usually includes the identifier of the joined client, the head of the joined client, the rank of the joined client, introduction information of the joined clients and so on. The corresponding relationship between each position and the identifier of a joined client represent the corresponding relationship between the identity of a client in the position and the position when the client joins in the position, such as, when the client “ZhangSan” joining the first position as the first client, the corresponding relationship between the identifier “0981” of the client “ZhangSan” and the first position. The group joining requirements are optional content, which usually at least includes one of the following items: whether the contribution value of the current channel reaching the predetermined threshold, whether the current reward points reaching the predetermined threshold and whether the privilege of the current channel reaching the requirement of predetermined privilege.

Because the group initiation request is initiated by the first client, the first client will be acquiescently considered to be a team leader to join in the first position. The corresponding relationship sent by the grouping server then includes the corresponding relationship between the first position and the identifier of the first client.

Accordingly, all the clients in the current channel will receive the group state information sent by the grouping server, for instance, the first client and at least one second client will receive the group state information sent by the grouping server.

Afterwards, each client in the current channel can acquire the currently latest group state according to the received group state information. Each client can show the position and the content of each position on the interface of itself according to the group state information. Combined with FIG. 4B, suppose the group state information includes: the number of the position “5”, the content types of the position “head +the nickname corresponding to the identifier +introduction”, the corresponding relationship between every position and the identifier of a joined client, wherein the corresponding relationship include the corresponding relationship between the first position and the identifier of the first client; thus, after the first client receiving the group state information, 5 positions 43 can be showed on the current interface, each position 43 showed the head 44, the nickname 45 corresponds to the identifier of the client and the introduction 46. Meanwhile, the first position shows “head + the nickname corresponding to the identifier + introduction” of the first client.

The showing display of the other clients can refer to FIG. 4B.

What is need to be specified is, the number of the positions, the content types of the position, the group joining requirements and other group setting information can be always remains the same, and also can be changed according to the requirement through setting. If the group setting information is changeable, thus before this step, the grouping server can read the group setting information preset by a client where an administrator of the current channel is located, wherein the group setting information includes all the following contents or the first two pieces of content in the total number of the positions, the content types of the positions and the group joining requirements. For example, the client where an administrator in the current channel is located can modify the group setting information during last grouping operation, and then the modified group setting information will take effect in this grouping operation.

Step 306, the second client sends group state reading request to the grouping server after the second enters the current channel.

Suppose the second client is not in the channel at the beginning, the second client enters the current channel after the first client sends the group state information, thus when the second client enters the current channel, the second client sends the group state reading request to the grouping server to acquire the currently latest group state information. If the second client is in the channel at the beginning, the second client has already maintained the proper group state information in the step 304.

Accordingly, the grouping server can receive the group state reading request sent by the second client which newly enters the current channel. The group state reading request usually carries an identifier of the second client.

Step 308, the grouping server sends group state information to the second client, wherein, the group state information is a currently latest group state information.

When receiving the group state reading request sent by the second client, the grouping server sends the group state information to the second client, wherein the group state information is the currently latest group state information. For instance, the grouping server sends the group state information to the second client according to the identifier of the second client through channel server in unicasting mode.

Accordingly, the second client can receives the group state information sent by the grouping server. The second client can also show the position and the content of each position according to the group state information, the displayed interface can refer to FIG. 4B.

Step 310, the second client sends a group joining request to the grouping server, wherein the group joining request includes an identifier of the second client and a position that the second client is to join.

When in need of joining the group, the second sends a group joining request to the grouping server. The group joining request includes the identifier of the second client and the position the second client is to join. Combined with FIG. 4B, when the cursor of the second client resting on the second position, the second client can click the “+” button 46 displayed on the position to join in on the interface of itself in order to send the group joining request to the grouping server.

Preferably, if the group state information includes the group joining requirements, the second client should detect whether the group joining requirements in the group state information are satisfied before sending the group joining request, wherein the group joining requirements at least includes one of the following items, which are whether the contribution value of the current channel reaching the predetermined threshold, whether the current reward points reaching the predetermined threshold and whether the privilege of the current channel reaching the requirement of predetermined privilege.

If the detecting result is that the group joining requirements in the group state information are satisfied, send the group joining request to the grouping server.

Else if the detecting result is that the group joining requirements in the group state information are not satisfied, do not send the group joining request to the grouping server.

Accordingly, the grouping server can receive the group joining request sent by the second client in the current channel, the group joining request including the identifier of the second client and the position the second client is to join.

Step 312, the grouping server updates the group state information and sends the group state information to all clients again in the current channel, wherein the corresponding relationship in the group state information includes a corresponding relationship between the second position and the identifier of the second client.

In order to get other clients know the second client has joined in the second position, the grouping server updates the group state information and sends the group state information to all the clients again in the current channel, the corresponding relationship of the group state information including the corresponding relationship between the second position and the identifier of the second client. All the clients currently in the channel include the first client and the second client.

Afterwards, each client in the current channel can acquires the currently latest group state according to the received group state information. Each client can displays the position and the content of each position on the interface of itself according to the group state information. For example, when the client “LiSi” joining the group as the second client, the displaying interface can refer to FIG. 4C. When receiving the group state information for the second time to the n time, each client can respectively compare the total number of the positions and the content types of the position in the currently received group state information with the total number of the positions and the content types of the position in group state information received last time, if the comparison result is the same, updating the corresponding relationship between every position and the identifier of the joined client; if the comparison result is different, redrawing and displaying the positions.

It should be noted that, the number of second clients can be more than one, for example, when the number of positions is 5, there at most can be 4 second clients to join the group, thus the 4 second clients becoming the group member of this group, which means step 310 and step 312 may be implemented repeatedly.

Step 314, the second client sends a group quitting request to the grouping server, wherein the group quitting request includes the identifier of the second client and the position that the second client is to quit.

Due to after joining the group, the second client still possibly choose to quit from the group before accomplishing grouping because of temporary emergency or reading wrong group information by mistake and so on. Under this situation, the second client can sends the group quitting request to the grouping server, wherein the group quitting request includes the identifier of the second client and the position that the second client is to quit. Combined with FIG. 4C, when the cursor of the second client resting on the second position, the second client can click the “quit” button 47 on the second position in order to send the group quitting request to the grouping server.

Accordingly, the grouping server receives the group quitting request sent by the second client, wherein the group quitting request includes the identifier of the second client and the position that the second client is to quit.

Step 316, the grouping server updates the group state information and sends the group state information to all clients again in the current channel, wherein the corresponding relationship in the group state information deletes the corresponding relationship between the second position and the identifier of the second client.

When receiving the group quitting request sent by the second client, the grouping server can remove the corresponding relationship between the second position and the identifier of the second client from the current corresponding relationship in the group state information. Then, the grouping server sends the group state information to all the clients again in the current channel, the corresponding relationship of the group state information removes the corresponding relationship between the second position and the identifier of the second client; so that each client can update the group state.

It may lead to the difference between the group state information in the client and the group state information in the grouping server because that the packet loss of the group state information and other reasons. Therefore, after receiving the group quitting request sent by the second client, the grouping server has to detect whether or not the identifier of the joined client responds to the position that the second client is to quit is the same as the identifier of the second client.

If the identifier of the joined client responds to the position that the second customer client is to quit is the same as the identifier of the second client, the group server removes the corresponding relationship between the second position and the identifier of the second client. Then, the grouping server sends the group state information to all the clients again in the current channel, wherein the corresponding relationship of the group state information having removed the corresponding relationship between the second position and the identifier of the second client; so that each client can update the group state.

If the identifier of the joined client corresponds to the position that the second client is to quit is different from the identifier of the second client, the grouping server sends the group state information to the second client again, wherein the group state information is currently latest group state information; so that the second client can updates the group state.

What need to be specified is, steps 314 to 316 are optional steps.

Step 318, the first client sends a group member kicking-out request to the grouping server, wherein the group member kicking-out request includes the corresponding relationship between the second position and the identifier of the second client.

Due to after the second client joining the group, the first client as the team leader possibly chose to kick out the second client before accomplishing grouping because of the dislike to the second client or the consideration of the wrong joining of the second client. Under this situation, the first client can sends the group member kicking-out request to the grouping server, the group member kicking-out request including the second position and the identifier of the second client. Combined with FIG. 4D, when the cursor of the first client resting on the second position, the first client can click the “remove from group” button 48 displayed on the second position in order to send the group kicking-out request to the grouping server, the group member kicking-out request including the corresponding relationship between the second position and the identifier of the second client.

Accordingly, the grouping server receives the group member kicking-out request sent by the first client, the group member kicking-out request including the corresponding relationship between the second position and the identifier of the second client.

Step 320, the grouping server updates the group state information and sends the group state information to all clients again in the current channel, wherein the corresponding relationship in the group state information deletes the corresponding relationship between the second position and the identifier of the second client.

When receiving the group member kicking-out request sent by the first client, the grouping server can remove the corresponding relationship between the second position and the identifier of the second client from the corresponding relationship in the current group state information. Then, the grouping server sends the group state information to all the clients again in the current channel, wherein the corresponding relationship of the group state information having removed the corresponding relationship between the second position and the identifier of the second client; so that each client can updates the group state.

It may lead to the difference between the group state information in the client and the group state information in the grouping server that the packet loss of the group state information or other reasons. Therefore, when receiving the group member kicking-out request sent by the first client, the grouping server has to detect whether or not the identifier of the joined client corresponds to the second client in the member kicking-out request is the same as the identifier of the second client.

If the identifier of the joined client corresponds to the second position in the member kicking request is the same as the identifier of the second client, the group server removes the current corresponding relationship between the second position and the identifier of the second client from the corresponding relationship in the current group state. Then, the grouping server sends the group state information to all the clients again in the current channel, wherein the corresponding relationship of the group state information having removed the corresponding relationship between the second position and the identifier of the second client, so that each client can updates the group state. Specially, after the grouping server receiving the member kicking-out request of the first client, the second client can also receives the group state information sent again by the grouping server, wherein the corresponding relationship of the group state information having removed the corresponding relationship between the second position and the identifier of the second client.

If the identifier of the joined client corresponds to the second position in the group kicking request is different from the identifier of the second client, sending the group state information to the first client again so that the first client can updates the group state, wherein the group state information is currently latest group state information.

What need to be explained is, steps 318 to 320 are also be optional. Wherein, steps 314 to 320 above may be implemented 0 to more times in a grouping operation.

Step 322, after every position has a corresponding identifier of a joined client, the grouping server moves the joined clients corresponding to all positions into the same sub-channel to accomplish grouping.

The grouping server accomplishes grouping by moving the joined clients which corresponds to all the positions respectively into the same sub-channel when every position has a corresponding identifier of the joined client. For example, when the number of position is 5, if each position has a client to join, the grouping server can moving the 5 joined clients into the same sub-channel to accomplish the grouping operation. Concretely speaking, after each position having a corresponding joined client, the grouping server receives the grouping accomplishing information sent by a client where the administrator of the current channel is located (not shown); when the grouping server receiving the grouping accomplishing information, the grouping server will moving every joined client corresponding to each the position respectively into the same sub-channel to accomplish the grouping.

For the first client or the second clients, when each position having a corresponding joined client, they will enter the same sub-channel with the other joined clients.

Optionally, the grouping operation may be cancelled before accomplished. That means before the step 322, the first client or the client where an administrator of the current channel is located could send a group cancelling request to the grouping server. After the grouping server receiving the group cancelling request, the grouping server cancels the grouping operation. Concretely, there can be following three conditions:

First condition, the first client sends the group cancelling request to the grouping server, wherein the group cancelling request is actively initiated by user, which means the first client cancel the grouping operation actively; referring to FIG. 4A, the first client can click the “cancel grouping” button displayed on the first position to send the group cancelling request to the grouping server. The grouping server cancels the current grouping operation, updates the group state information and sends the group state information to all the clients in the current channel again, the group state information including all the four pieces or the first three pieces of content in the total amount of the positions, the content types of the positions, the corresponding relationship between each position and the identifier of a joined client and the group joining requirements, however the corresponding relationship is empty. The total number of positions can be the number of occupied positions and non-occupied positions, or the number of non-occupied positions. The first client and the other clients in the current channel receive the group state information sent again by the grouping server, and then the current grouping operation is cancelled, waiting next grouping operation.

Second condition, the first client sends the group cancelling request to the grouping server, wherein the group cancelling request is triggered automatically when exceeding a predetermined period after sending the group initiation request, which means when sending the group cancelling request, the first client occupies the microphone time. If the grouping operation has not been accomplished until the microphone time expires, the first client will cancel the grouping operation automatically. The first client can send the group cancelling request to the grouping server automatically when the “the current microphone time remains” in FIG. 4D is Os. The grouping server cancels the current grouping operation, updates the group state information and sends the group state information to all the clients in the current channel again, wherein the group state information includes the following four pieces or the first three pieces of content in the total number of the positions, the content types of the positions, the corresponding relationship between every position and the identifier of a joined client and the group joining requirements, however the corresponding relationship is empty. The total number of positions can be the number of occupied positions and non-occupied positions, or the number of non-occupied positions. The first client and other clients in the current channel receive the group state information sent again by the grouping server to cancel the current grouping operation and wait the next grouping operation.

Third condition, the client where an administrator of the current channel is located also can send the group cancelling request to the grouping server, for instance, if the administrator of the current channel removes the first client from the microphone sequence, the client where the administrator of the current channel is located will send the group cancelling request to the grouping server. The grouping server cancels the current grouping operation, updates the group state information and sends the group state information to all the clients in the current channel again, wherein the group state information includes all the following four pieces or the first three pieces of content in the total number of the positions, the content types of the positions, the corresponding relationship between each position and the identifier of a joined client and the group joining requirements, however the corresponding relationship is empty. The total number of positions can be the number of occupied positions and non-occupied positions, or the number of non-occupied positions. The first client and other clients in the current channel receive the group state information sent by the grouping server again to cancel the current grouping operation and wait the next grouping operation.

In conclusion, the grouping method provided by the embodiment of present disclosure, by means of receiving a group initiation request sent by the first client in the current channel, sending the group state information to all the clients in the current channel and receiving a group joining request sent by the second client according to the group state information in the current channel; solving the problem of unable to form a group successfully when the channel number is not known to other client; achieving the effect that as long as the first client initiates a grouping operation in the current channel, the second clients can join the group freely to accomplish a grouping operation. Furthermore, by means of providing the functions of group quitting, group member kicking-out, group cancelling and other functions, making the first client accomplish the whole grouping operation freely and deal with the problems which could happen occasionally during the grouping operation. And using the channel server as the transfer server to transfer bidirectional requests or information, the group communication tool can reuse the original system structure as far as possible, which is more compatible with the original system structure. However, what the technicians in this art easy to conclude is that, the channel server is not the essential equipment, in the other embodiments only the client and the grouping server have to be included, thus the clients and the grouping server communicate directly.

What need to be specified is, according to the different implementing subjects, some steps of the grouping method above can be divided to be performed and achieve the grouping method used by the grouping server, the first client and the second client implement separately.

Embodiment Three

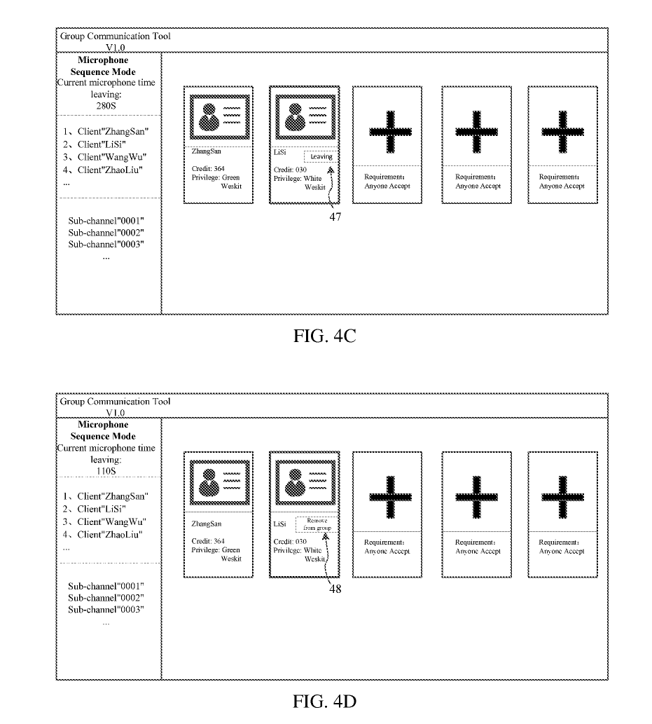

Referring to FIG. 5, it shows a structure diagram of a grouping system provided by a third embodiment of the present disclosure. The grouping system includes a first client 520, a second client 540 and a grouping server 560.

The first client 520, including: a first sending module 522, a state receiving module 524 and a channel entering module 526.

The first sending module 522 is configured to send the group initiation request to the grouping server 560. The group initiation request carries an identifier of the first client.

The state receiving module 524 is configured to receive the group state information sent by the grouping server 560, wherein the group state information includes all the following four pieces of content or the first three pieces of content in the total number of positions, the content types of the positions, the corresponding relationship between each position and the identifier of a joined client and group joining requirements, wherein the corresponding relationship includes the corresponding relationship between the first position and the identifier of the first client. The total number of positions can be the number of occupied positions and non-occupied positions, or the number of non-occupied positions.

Wherein, the state receiving module 524 is further configured to receive the group state information sent again by the grouping server 560, wherein the corresponding relationship in the group state information includes a corresponding relationship between the second position and an identifier of the second client.

The channel entering module 526 is configured to enter the same sub-channel with other joined clients to accomplish grouping when each position has the corresponding identifier of a joined client.

The second client 540, including: a state receiving module 542, a second sending module 544 and a channel entering module 546.

The state receiving module 542 is configured to receive the group state information sent by the grouping server 560. The group state information includes all four pieces of content or the first three pieces of content in the total number of the positions, content types of the positions, corresponding relationship between each position and an identifier of a joined client and group joining requirements, wherein the corresponding relationship includes the corresponding relationship between the first position and the identifier of the first client. The total number of positions can be the number of occupied positions and non-occupied positions, or the number of non-occupied positions.

The second sending module 544 is configured to send the group joining request to the grouping server 560. The group joining request includes the identifier of second client and a position that the second client is to join.

The state receiving module 542 is further configured to receive the group state information sent again by the grouping server 560. Corresponding relationship in the group state information includes the corresponding relationship between the second position and the identifier of the second client.

The channel entering module 546 is configured to move joined clients corresponding to all positions into the same sub-channel to accomplish grouping, after every position has a corresponding identifier of a joined client.

A grouping server 560, including: a first receiving module 562, a state broadcasting module 564, a second receiving module 566 and a channel shifting-in module 568.

The first receiving module 562 is configured to receive the group initiation request sent by the first client 520 in the current channel. The group initiation request carries the identifier of the first client.

The state broadcasting module 564 is configured to send the group state information to all the clients in the current channel. The group state information including all four pieces of content or the first three pieces of content in the total number of positions, content types of the position, corresponding relationship between each position and the identifier of a joined client and the group joining requirements, wherein the corresponding relationship includes the corresponding relationship between the first position and the identifier of the first client. The total number of positions can be the number of occupied positions and non-occupied positions, or the number of non-occupied positions.

A second receiving module 566 is configured to receive the group joining request sent by the second client 540 in the current channel. The group joining request includes an identifier of second client and a position that the second client is to join.

The state broadcasting module 564 is further configured to update the group state information and send the group state information to all clients again in the current channel. The corresponding relationship in the group state information includes the corresponding relationship between the second position and the identifier of the second client.

A channel shifting-in module 568 is configured to move each joined client corresponding to each position into the same sub-channel after every position has a corresponding identifier of a joined client received from the first receiving module 562 or the second receiving module 566.

In conclusion, the grouping method provided by this embodiment of the disclosure, by means of receiving a group initiation request sent by the first client in the current channel, sending the group state information to all the clients in the current channel and receiving a group joining request sent by the second client according to the group state information in the current channel; solving the problem of unable to form a group successfully when the channel number is not known to other client; achieving the effect that as long as the first client initiates a grouping operation in the current channel, the second client can join the group freely to accomplish a grouping operation.

Embodiment Four

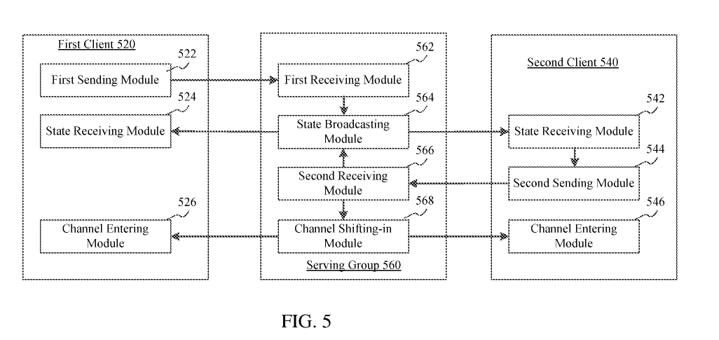

Referring to FIG. 6, it shows a structure diagram of a grouping system provided by the embodiment four of present disclosure. More preferable than the embodiment three, this grouping system includes a first client 520, a second client 540 and a grouping server 560. Wherein,

A first client 520, including: a first sending module 522, a state receiving module 524 and a channel entering module 526.

The first sending module 522 is configured to send a group initiation request to the grouping server 560, the group initiation request carrying the identifier of the first client.

The state receiving module 524 is configured to receive group state information sent by the grouping server 560, the group state information including all the following four pieces or the first three pieces of content in the total number of positions, content types of the position, corresponding relationship between each position and the identifier of a joined client and group joining requirements, wherein the corresponding relationship includes the corresponding relationship between the first position and the identifier of the first client.

The state receiving module 524 is further configured to receive the group state information sent again by the grouping server 560, the corresponding relationship in the group state information including a corresponding relationship between second position and an identifier of the second client.

The channel entering module 526 is configured to enter the same sub-channel with other joined clients to accomplish grouping after every position has a corresponding identifier of a joined client.

Preferably, the first client further includes a forth sending module 527.

The forth sending module 527 is configured to send a group member kicking-out request to the grouping server 560, the group member kicking-out request including the corresponding relationship between the second position and the identifier of the second client.

The state receiving module 524 is further configured to receive the group state information sent again by the grouping server 560, the corresponding relationship in the group state information having removed the corresponding relationship between the second position and the identifier of the second client, or the group state information is currently latest group state information.

Preferably, the first client 520 further includes a sixth sending module 529.

The sixth sending module 529 is configured to send a group cancelling request to the grouping server 560, wherein the group cancelling request sent by the first client is a request that is actively initiated by a user or is automatically triggered after a predetermined period of sending the group initiation request.

The state receiving module 524 is further configured to receive the group state information sent again by the grouping server 560, the group state information including all the following four pieces or the first three pieces of content in the total number of the positions, the content types of the positions, the corresponding relationship between each position and the identifier of a joined client and the group joining requirements, however the corresponding relationship is empty.

The second client 540, including: a state receiving module 542, a second sending module 544 and a channel entering module 546.

The state receiving module 542 is configured to receive the group state information sent by the grouping server 560, the group state information including all the following four pieces or the first three pieces of content in the total number of the positions, the content types of the positions, the corresponding relationship between each position and an identifier of a joined client and the group joining requirements, wherein the corresponding relationship includes the corresponding relationship between the first position and the identifier of the first client.

The second sending module 544 is configured to send a group joining request to the grouping server 560, the group joining request including an identifier of second client and a position that the second client is to join.

The state receiving module 542 is further configured to receive the group state information sent again by the grouping server 560, the corresponding relationship in the group state information including a corresponding relationship between the second position and the identifier of the second client.

The channel entering module 546 is configured to move joined clients corresponding to all positions into the same sub-channel to accomplish grouping, after every position has a corresponding identifier of a joined client.

Preferably, the second client 540 further includes a requirement detecting module 543.

The requirement detecting module 543 is configured to detect whether the group joining requirements in the group state information are satisfied, the group joining requirements including at least one of following items, which include contribution value to the current channel reaching a predetermined threshold, current reward points reaching a predetermined threshold and privilege of the current channel reaching a predetermined requirement of privilege.

The second sending module 544 is further configured to implementing the step of sending the group joining request to the grouping server if the detecting result is that the group joining requirements in the group state information are satisfied.

Preferably, the second client 540 further includes a third sending module 547.

The third sending module 547 is configured to send the group quitting request to the grouping server 560, the group quitting request including the identifier of the second client and the position that the second client is to quit.

The state receiving module 542 is further configured to receive the group state information sent again by the grouping server 560, the corresponding relationship in the group state information having removed the corresponding relationship between the second position and the identifier of the second client, or the group state information is currently latest group state information.

Preferably, the state receiving module 542 is further configured to receive the group state information sent again by the grouping server 560 after the grouping server receiving the group member kicking-out request sent by the first client, the corresponding relationship in the group state information having removed the corresponding relationship between the second position and the identifier of the second client.

Preferably, the second client 540 further includes a fifth sending module 549.

The fifth sending module 549 is configured to send group state information reading request to the grouping server after the second client entering the current channel.

A grouping server 560, including: a first receiving module 562, a state broadcasting module 564, a second receiving module 566 and a channel shifting-in module 568.

The first receiving module 562 is configured to receive the group initiation request sent by the first client 520 in the current channel, the group initiation request carrying the identifier of the first client.

The state broadcasting module 564 is configured to send the group state information to all the clients in the current channel, the group state information including all the following four pieces or the first three pieces of content in the total number of positions, the content types of the position, the corresponding relationship between each position and the identifier of a joined client and the group joining requirements, wherein the corresponding relationship includes the corresponding relationship between the first position and the identifier of the first client. The total number of positions can be the number of occupied positions and non-occupied positions, or the number of non-occupied positions.

The second receiving module 566 is configured to receive the group joining request sent by a second client 540 in the current channel, the group joining request including the identifier of second client and the position that the second client is to join.

The state broadcasting module 564 is further configured to update the group state information and send the group state information to all clients again in the current channel, the corresponding relationship in the group state information including the corresponding relationship between the second position and the identifier of the second client.

The channel shifting-in module 568 is configured to move each joined client corresponding to each position into the same sub-channel when every position has the corresponding identifier of a joined client received from the first receiving module 562 or the second receiving module 566.

Preferably, the grouping server 560 further includes a setting reading module 563.

The setting reading module 563 is configured to read the group setting information preset by a client where an administrator of the current channel is located, wherein the group setting information includes all the following three pieces or the first two pieces of content in the total number of the positions, the content types of the positions and the group joining requirements.

Preferably, the grouping server 560 further includes a joining detecting module 567 and a state unicasting module 569.

The joining detecting module 567 is configured to detect whether or not the identifier of the joined client corresponding to the position that the second client is to join received from the second receiving module 566 is empty.

The state broadcasting module 564 is further configured to implement the step of updating the group state information and sending the group state information to all the clients again in the current channel if the joining detecting module 567 detects that the identifier of the joined client corresponding to the position the second client is to join is empty.

The state unicasting module 569 is configured to send the group state information to the second client 540 again; the group state information is currently latest group state information if the joining detecting module detects that the identifier of the joined client corresponding to the position that the second client is to join is not empty.

Preferably, the grouping server 560 further includes a third receiving module 601.

The third receiving module 601 is configured to receive the group quitting request sent by the second client 540, the group quitting request including the identifier of the second client and the position that the second client is to quit.

The state broadcasting module 564 is further configured to update the group state information and send the group state information to all the clients again in the current channel, the corresponding relationship in the group state information having removed the corresponding relationship between the second position and the identifier of the second client received from the third receiving module.

Preferably, the grouping server 560 further includes a quitting detecting module 602.

The quitting detecting module 602 is configured to detect whether or not the identifier of the joined client corresponding to the position that the second client is to quit received from the third receiving module 601 is the same as the identifier of the second client.

The state broadcasting module 564 is further configured to implement the step of updating the group state information and sending the group state information to all the clients again in the current channel if the quitting detecting module 602 detects that the identifier of the joined client corresponding to the position that the second client is to quit is the same as the identifier of the second client.

The state unicasting module 569 is further configured to send the group state information to the second client again, wherein the group state information is currently latest group state information if the quitting detecting module 602 detects that the identifier of the joined client corresponding to the position that the second client is to quit is different from the identifier of the second client.

Preferably, the grouping server 560 further includes a forth receiving module 603.

The forth receiving module 603 is configured to receive the group member kicking-out request from the first client, the group member kicking-out request including the corresponding relationship between the second position and the identifier of the second client.

The state broadcasting module 564 is further configured to update the group state information and send the group state information to all the clients again in the current channel, the corresponding relationship in the group state information having removed the corresponding relationship between the second position received from the forth receiving module and the identifier of the second client.

Preferably, the grouping server 560 further includes a kicking-out detecting module 604.

The kicking detecting module 604 is configured to detect whether or not the identifier of the joined client corresponding to the second position in the group member kicking-out request received from the forth receiving module 603 is the same as the identifier of the second client.

The state broadcasting module 564 is further configured to implement the step of updating the group state information and sending the group state information to all the clients again in the current channel, if the kicking detecting module 603 detects that the identifier of the joined client corresponding to the second position in the group member kicking-out request is the same as the identifier of the second client.

The state unicasting module 569 is further configured to send the group state information to the first client again, wherein the group state information is currently latest group state information, if the kicking detecting module 603 detects that the identifier of the joined client corresponding to the second position in the group member kicking-out request is different from the identifier of the second client.

Preferably, the grouping server 560 further includes a fifth receiving module.

The fifth receiving module 605 is configured to receive the group state reading request sent by a second client 540 which newly enters in the current channel.

The state unicasting module 569 is further configured to the group state information to the second client 540, which is currently latest group state information.

Preferably, the grouping server 560 further includes a sixth receiving module 606.

The sixth receiving module 606 is configured to receive the group cancelling request sent by the first client 520 or the client where an administrator of the current channel is located, wherein the group cancelling request sent by the first client 520 is a request that is actively initiated by a user or is automatically triggered after a predetermined period of sending the group initiation request.

The state broadcasting module 564 is further configured to update the group state information and send the group state information to all clients in the current channel again, the group state information including all the following four pieces or the first three pieces of content in the total number of the positions, the content types of the positions, the corresponding relationship between each position and the identifier of a joined client and the group joining requirements, however the corresponding relationship is empty.

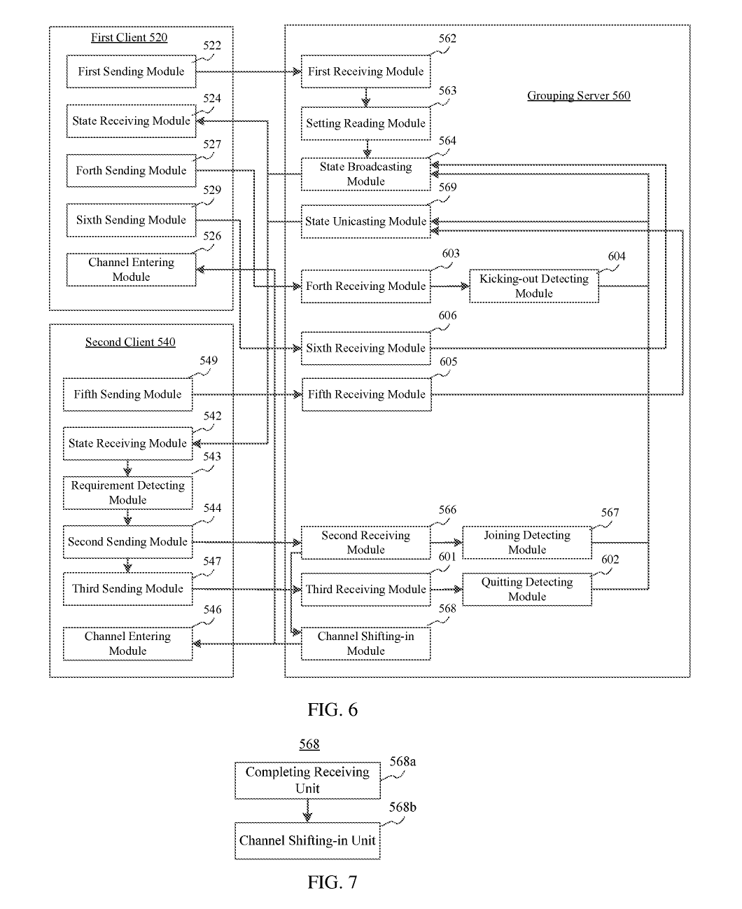

Preferably, the channel shifting-in module 568 further includes a completing receiving unit 568a and a channel shifting-in unit 568b, which is shown as FIG. 7.

The completing receiving unit 568a is configured to receive the grouping accomplishing information sent by a client where an administrator of the current channel is located, after every position has a corresponding identifier of a joined client.

The channel shifting-in unit 568b is configured to move the joined clients corresponding to all the positions into the same sub-channel to accomplish grouping upon receiving the grouping accomplishing information from the completing receiving unit 568a.

Preferably, the grouping system can further include a channel server (not shown), the grouping server 560 using the channel server as a transfer server to receive the requests from every client in the current channel.

And/or, the grouping server 560 utilizing the channel server as the transfer server to send information to every client in the current channel in form of broadcasting mode or unicasting mode.

In conclusion, the grouping method provided by this embodiment of present disclosure, by means of receiving a group initiation request sent by the first client in the current channel, sending the group state information to all the clients in the current channel and receiving a group joining request sent by the second client according to the group state information in the current channel; solving the problem of unable to form a group successfully when the channel number is not known to other client; achieving the effect that as long as the first client initiates a group in the current channel, the second client can join the group freely to accomplish a grouping operation. Also by means of providing the functions of group quitting, group member kicking-out, group cancelling and other functions, making the first client accomplish the whole grouping operation freely and deal with the problems that could happen during the grouping operation. Also by means of using the channel server as the transfer server to transfer bidirectional requests or information, which makes the group communication tool reuse the original system structure as far as possible, and be more compatible with the original system structure.

What need to be explained is, the grouping system provided by the embodiments above, in the grouping operation, only give examples according to the differentiations of each function module above. In the practical application, the functions above can be implemented by different function modules, which mean dividing the internal structure of the equipment into different function modules to complete all or part of functions described above. Additionally, the grouping system provided by the embodiment above and the grouping method of embodiments above should be regarded as the same design conception, the concrete implementation process of the grouping system referring to the grouping method embodiments, without more description.

The numerical number of the embodiments of this disclosure is only for conveniently describing, should not be concerned with the priority or effect of the embodiments.

It should be understood that, for a person having ordinary skills in the art, all or part of the steps of above embodiments can be performed by the hardware or by the computer program instructing the relevant hardware. The program may be stored in a computer readable storage medium, wherein the storage medium may be but not limited to a Read-Only Memory (ROM), a magnetic disk, an optical disk or a Random Access Memory (RAM), etc.

The descriptions above are only the preferable embodiments of this disclosure, and should not be regarded as limitation to the scope of related claims. Any modification, equivalent replacement and improvement under the design principle of this disclosure should be incorporated by the protection scope of this disclosure.

1. A grouping method, comprising:
receiving a group initiation request sent by a first client in a current channel, the group initiation request carrying an identifier of the first client;
sending group state information to all clients in the current channel, wherein the group state information comprises all four or the first three of the total number of positions, content types of the positions, a corresponding relationship between each position and an identifier of a joined client, and group joining requirements, wherein the corresponding relationship comprises a corresponding relationship between a first position and the identifier of the first client;
receiving a group joining request sent by a second client in the current channel, the group joining request comprising an identifier of the second client and a position that the second client is to join;
updating the group state information and sending the group state information to all clients again in the current channel, wherein the corresponding relationship in the group state information comprises a corresponding relationship between the second position and the identifier of the second client; and
after every position has a corresponding identifier of a joined client, moving joined clients corresponding to all positions into the same sub-channel to accomplish grouping.

2. (canceled)

3. (canceled)

4. The grouping method according to claim 1, further comprising:
in response to sending the group state information to all clients again in the current channel, wherein the corresponding relationship in the group state information comprises a corresponding relationship between the second position and the identifier of the second client, receiving a group quitting request sent by the second client, the group quitting request comprising the identifier of the second client and the position that the second client is to quit; and
updating the group state information and sending the group state information to all clients again in the current channel, the corresponding relationship between the second position and the identifier of the second client having been removed from the corresponding relationship in the group state information.

5. (canceled)

6. The grouping method according to claim 1, further comprising:
in response to sending the group state information to all clients again in the current channel, wherein the corresponding relationship in the group state information comprises a corresponding relationship between the second position and the identifier of the second client, receiving a group member kicking-out request sent by the first client, the group member kicking-out request comprising the corresponding relationship between the second position and the identifier of the second client; and
updating the group state information and sending the group state information to all clients again in the current channel, the corresponding relationship in the group state information having removed the corresponding relationship between the second position and the identifier of the second client.

7. (canceled)

8. (canceled)

9. The grouping method according to claim 1, further comprising:
in response to sending group state information to all clients in the current channel, receiving a group cancelling request sent by the first client or a client where an administrator of the current channel is located, wherein the group cancelling request sent by the first client is a request that is actively initiated by a user or is automatically triggered after a predetermined period of sending the group initiation request; and
updating the group state information and sending the group state information to all clients in the current channel again, the group state information comprising all four or the first three of the total number of the positions, the content types of the positions, the corresponding relationship between each position and the identifier of the joined client and the group joining requirements, wherein the corresponding relationship is empty.

10. (canceled)

11. (canceled)

12. A grouping method, used in a first client, comprising:
sending a group initiation request to a grouping server, the group initiation request carrying an identifier of the first client;
receiving group state information sent by the grouping server, wherein the group state information comprises all four or the first three of the total number of positions, content types of the positions, a corresponding relationship between each position and an identifier of a joined client, and group joining requirements, wherein the corresponding relationship comprises a corresponding relationship between a first position and the identifier of the first client;
receiving the group state information sent again by the grouping server, wherein the corresponding relationship in the group state information comprises a corresponding relationship between a second position and a identifier of a second client; and
after every position has a corresponding identifier of a joined client, entering the same sub-channel with other joined clients to accomplish grouping.

13. The grouping method according to claim 12, further comprising:
in response to after every position has a corresponding identifier of a joined client, entering the same sub-channel with other joined clients to accomplish grouping, sending a group member kicking-out request to the grouping server, the group member kicking-out request comprising the corresponding relationship between the second position and the identifier of the second client; and
receiving the group state information sent again by the grouping server, wherein the corresponding relationship between the second position and the identifier of the second client has been removed from the corresponding relationship in the group state information, or the group state information is currently latest group state information.

14. The grouping method according to claim 12, further comprising:
in response to sending a group initiation request to a grouping server, sending a group cancelling request to the grouping server, wherein the group cancelling request is a request that is actively initiated by a user or is automatically triggered after a predetermined period of sending the group initiation request; and
receiving the group state information sent again by the grouping server, wherein the group state information comprises all four or the first three of the total number of the positions, the content types of the positions, the corresponding relationship between each position and the identifier of the joined client, and the group joining requirements, wherein the corresponding relationship is empty.

15. A grouping method used in a second client, comprising:
receiving group state information sent by a grouping server, wherein the group state information comprises all four or the first three of the total number of the positions, content types of the positions, a corresponding relationship between each position and an identifier of a joined client and the group joining requirements, wherein the corresponding relationship comprises a corresponding relationship between a first position and an identifier of the first client;
sending a group joining request to the grouping server, the group joining request comprising an identifier of the second client and a position that the second client is to join;
receiving the group state information sent again by the grouping server, wherein the corresponding relationship in the group state information comprises a corresponding relationship between second position and the identifier of the second client; and
after every position has a corresponding identifier of a joined client, moving joined clients corresponding to all positions into the same sub-channel to accomplish grouping.

16. (canceled)

17. The grouping method according to claim 15, further comprising:
in response to sending a group joining request to the grouping server, sending a group quitting request to the grouping server, the group quitting request comprising the identifier of the second client and the position that the second client is to quit; and
receiving the group state information sent again by the grouping server, wherein the corresponding relationship between the second position and the identifier of the second client has been removed from the corresponding relationship in the group state information, or the group state information is currently latest group state information.

18. The grouping method according to claim 15, further comprising:
in response to receiving the group state information sent again by the grouping server, wherein the corresponding relationship in the group state information comprises a corresponding relationship between second position and the identifier of the second client, receiving the group state information sent again by the grouping server after receiving a group member kicking-out request sent by the first client, the corresponding relationship in the group state information having removed the corresponding relationship between the second position and the identifier of the second client.

19. (canceled)

20. A grouping server , the server comprising:
a first receiving module, configured to receive a group initiation request sent by a first client in the current channel, the group initiation request carrying an identifier of the first client;
a state broadcasting module, configured to send group state information to all the clients in the current channel, wherein the group state information comprises all four or the first three of the total number of positions, content types of the position, a corresponding relationship between each position and an identifier of a joined client, and group joining requirements, wherein the corresponding relationship comprises a corresponding relationship between a first position and an identifier of the first client;
a second receiving module, configured to receive a group joining request sent by a second client in the current channel, the group joining request comprising an identifier of the second client and a position that the second client is to join, wherein the state broadcasting module is further configured to update the group state information and send the group state information to all clients again in the current channel, wherein the corresponding relationship in the group state information comprises the corresponding relationship between the second position and the identifier of the second client; and
a channel shifting-in module, configured to move each joined client corresponding to each position into the same sub-channel after every position has a corresponding identifier of a joined client received from the first receiving module or the second receiving module.

21. (canceled)

22. (canceled)

23. The server according to claim 20, further comprising a third receiving module configured to receive a group quitting request sent by the second client, the group quitting request comprising the identifier of the second client and the position that the second client is to quit, wherein the state broadcasting module is further configured to update the group state information and send the group state information to all clients again in the current channel, the corresponding relationship between the second position and the identifier of the second client received from the third receiving module having been removed from the corresponding relationship in the group state information.

24. (canceled)

25. The server according to claim 20, further comprising a forth receiving module configured to receive the group member kicking-out request sent by the first client, the group member kicking-out request comprising the corresponding relationship between the second position and the identifier of the second client, wherein the state broadcasting module is further configured to update the group state information and send the group state information to all the clients again in the current channel, the corresponding relationship between the second position received from the forth receiving module and the identifier of the second client having been removed from the corresponding relationship in the group state information.

26. (canceled)

27. (canceled)

28. The server according to claim 20, further comprising a sixth receiving module configured to receive the group cancelling request sent by the first client or a client where an administrator of the current channel is located, wherein the group cancelling request sent by the first client is a request that is actively initiated by a user or is automatically triggered after a predetermined period of sending the group initiation request, wherein the state broadcasting module is further configured to update the group state information and send the group state information to all clients in the current channel again, wherein the group state information comprises all four or the first three of the total number of the positions, the content types of the positions, the corresponding relationship between each position and the identifier of the joined client, and the group joining requirements, wherein the corresponding relationship is empty.

29. (canceled)

30. (canceled)

31. A first client, comprising:
a first sending module, configured to send a group initiation request to grouping server, the group initiation request carrying an identifier of the first client;
a state receiving module, configured to receive group state information sent by the grouping server, wherein the group state information comprises all four or the first three of the total number of positions, content types of the position, corresponding relationship between each position and an identifier of a joined client, and group joining requirements, wherein the corresponding relationship comprises a corresponding relationship between the first position and the identifier of the first client,
the state receiving module, further configured to receive the group state information sent again by the grouping server, wherein corresponding relationship in the group state information comprises a corresponding relationship between a second position and an identifier of the second client; and
a channel entering module, configured to enter the same sub-channel with other joined clients to accomplish grouping after every position has a corresponding identifier of a joined client.

32. The first client according to claim 31, further comprising a forth sending module configured to send a group member kicking-out request to the grouping server, the group member kicking-out request comprising the corresponding relationship between the second position and the identifier of the second client, wherein the state receiving module is further configured to receive the group state information sent again by the grouping server, and wherein the corresponding relationship between the second position and the identifier of the second client has been removed from the corresponding relationship in the group state information, or the group state information is currently latest group state information.

33. The first client according to claim 31, further comprising a sixth sending module configured to send a group cancelling request to the grouping server, wherein the group cancelling request sent by the first client is a request that is actively initiated by a user or is automatically triggered after a predetermined period of sending the group initiation request, wherein the state receiving module is further configured to receive the group state information sent again by the grouping server, wherein the group state information comprises all four or the first three of the total number of the positions, the content types of the positions, the corresponding relationship between each position and the identifier of the joined client, and the group joining requirements, wherein the corresponding relationship is empty.

34. A second client, comprising:
a state receiving module, configured to receive group state information sent by the grouping server, wherein the group state information comprises all four or the first three of the total number of the positions, content types of the positions, a corresponding relationship between each position and an identifier of a joined client, and group joining requirements, wherein the corresponding relationship comprises a corresponding relationship between a first position and an identifier of the first client;
a second sending module, configured to send a group joining request to the grouping server, the group joining request comprising an identifier of the second client and a position that the second client is to join,
the state receiving module, further configured to receive the group state information sent again by the grouping server, wherein the corresponding relationship in the group state information comprises a corresponding relationship between a second position and the identifier of the second client; and
a channel entering module, configured to enter the same sub-channel with other joined clients to accomplish grouping after every position has a corresponding identifier of the joined client.

35. (canceled)

36. The second client according to claim 34, further comprising a third sending module configured to send a group quitting request to the grouping server, the group quitting request comprising the identifier of the second client and the position that the second client is to quit, wherein the state receiving module is further configured to receive the group state information sent again by the grouping server, and wherein the corresponding relationship between the second position and the identifier of the second client has been removed from the corresponding relationship in the group state information, or the group state information is currently latest group state information.

37. The second client according to claim 34, the state receiving module further configured to receive the group state information sent again by the grouping server, after the grouping server receives a group member kicking-out request sent by the first client, the corresponding relationship between the second position and the identifier of the second client having been removed from the corresponding relationship in the group state information.

38. (canceled)

39. (canceled)

40. (canceled)
